(19) United States
(12) Patent Application Publication
(10) Pub. No.: US 2025/0258333 A1
(43) Pub. Date: Aug. 14, 2025

(54) MULTICORE OPTICAL FIBER

(71) Applicant: SUMITOMO ELECTRIC INDUSTRIES, LTD., Osaka (JP)

(72) Inventors: Takemi HASEGAWA, Osaka (JP); Tetsuya HARUNA, Osaka (JP); Hirotaka SAKUMA, Osaka (JP); Takahiro SUGANUMA, Osaka (JP); Shin SATO, Osaka (JP); Yuto KOBAYASHI, Osaka (JP)

(21) Appl. No.: 19/052,505

(22) Filed: Feb. 13, 2025

(30) Foreign Application Priority Data
Feb. 14, 2024 (JP) 2024-020217
Oct. 11, 2024 (JP) 2024-178618

(51) Int. Cl. G02B 6/02

(52) U.S. Cl. CPC G02B 6/02042; G02B 6/02285

(57) ABSTRACT

A multicore optical fiber includes a plurality of cores along a fiber axis and cladding surrounding the plurality of cores. The plurality of cores includes a first core having an elliptical shape in a cross section orthogonal to the fiber axis and one or more second cores different from the first core. The non-circularity of the elliptical shape is 0.1% or more. In the cross section orthogonal to the fiber axis, an angle formed by a straight line connecting a center of gravity of the first core and a center of gravity of a core group including one or more second cores and a straight line along a major axis of the elliptical shape is 30 degrees or less. Polarization mode dispersion is 0.2 ps/rtkm or less.

### TECHNICAL FIELD

The present disclosure relates to a multicore optical fiber. The present application claims priority based on Japanese Patent Application No. 2024 020217 filed on Feb. 14, 2024 and priority based on Japanese Patent Application No. 2024-178618 filed on Oct. 11, 2024, the entire contents of which are incorporated herein by reference.

### BACKGROUND

There is known a technique for reducing polarization mode dispersion (PMD) in a multicore optical fiber including a plurality of cores and cladding surrounding the plurality of cores. For example, in a method for manufacturing a multicore optical fiber disclosed in US 2015/0307387 A1, a plurality of core canes having no hole in the center is inserted into holes of a soot blank to be cladding, and the core canes and the soot blank are sintered. As a result, low non-axial symmetry is achieved near the center of the core cane, and lower polarization mode dispersion is achieved. US 2011/0206330 A1 discloses that a plurality of multicore units included in a multicore optical fiber has threefold or more rotational symmetry, so that structural asymmetry is reduced and an increase in polarization mode dispersion is prevented.

### SUMMARY

A multicore optical fiber according to an embodiment of the present disclosure includes a plurality of cores along a fiber axis and cladding surrounding the plurality of cores, in which the plurality of cores and the cladding contain silica glass as a main component, a refractive index of each of the plurality of cores is higher than a refractive index of the cladding, a coefficient of thermal expansion of each of the plurality of cores is higher than a coefficient of thermal expansion of the cladding, the plurality of cores includes a first core having an elliptical shape in a cross section orthogonal to the fiber axis and one or more second cores different from the first core, non-circularity of the elliptical shape is 0.1% or more, an angle formed by a straight line connecting a center of gravity of the first core and a center of gravity of a core group including the one or more second cores and a major axis of the elliptical shape in the cross section orthogonal to the fiber axis is 30 degrees or less, and polarization mode dispersion is 0.2 ps/rtkm or less.

### BRIEF DESCRIPTION OF THE DRAWINGS

FIG. 1 is a perspective view of an optical fiber according to a first embodiment;

FIG. 2 is a cross-sectional view of the optical fiber orthogonal to a fiber axis;

FIG. 3 is a graph schematically illustrating a distribution of a coefficient of thermal expansion in the optical fiber;

FIG. 4 is a graph schematically illustrating a distribution of viscosity in the optical fiber;

FIG. 5 is a graph schematically illustrating a distribution of stress in the optical fiber;

FIG. 6 is a view schematically illustrating in-plane stress in a cross section orthogonal to the fiber axis;

FIG. 7 is a view schematically illustrating a slow axis direction of birefringence of a fundamental mode in a core;

FIG. 8 is a cross-sectional view of an optical fiber according to a second embodiment;

FIG. 9 is a cross-sectional view of an optical fiber according to a third embodiment;

FIG. 10 is a cross-sectional view of an optical fiber according to a modification;

FIG. 11 is a cross-sectional view of an optical fiber according to a modification;

FIG. 12 is a cross-sectional view of an optical fiber according to a modification; and

FIG. 13 is a view schematically illustrating an internal structure of the optical fiber according to the modification.

### DETAILED DESCRIPTION

### Problem to be Solved by Present Disclosure

Even in a multicore optical fiber in which low non-axial symmetry is achieved near the center of a core as disclosed in US 2015/0307387 A1, polarization mode dispersion may be high in a case where the arrangement of the cores does not have threefold or more rotational symmetry. Therefore, there is a demand for a multicore optical fiber capable of reducing polarization mode dispersion even in a case where the arrangement of the cores does not have threefold or more rotational symmetry.

An object of the present disclosure is to provide a multicore optical fiber capable of reducing polarization mode dispersion.

### Effects of Present Disclosure

The present disclosure provides a multicore optical fiber capable of reducing polarization mode dispersion.

### Description of Embodiments of Present Disclosure

First, contents of embodiments of the present disclosure will be listed and described.

(1) A multicore optical fiber according to an aspect of the present disclosure includes a plurality of cores along a fiber axis and cladding surrounding the plurality of cores, in which the plurality of cores and the cladding contain silica glass as a main component, a refractive index of each of the plurality of cores is higher than a refractive index of the cladding, a coefficient of thermal expansion of each of the plurality of cores is higher than a coefficient of thermal expansion of the cladding, the plurality of cores includes a first core having an elliptical shape in a cross section orthogonal to the fiber axis and one or more second cores different from the first core, non-circularity of the elliptical shape is 0.1% or more, an angle formed by a straight line connecting a center of gravity of the first core and a center of gravity of a core group including the one or more second cores and a straight line along a major axis of the elliptical shape is 30 degrees or less in the cross section orthogonal to the fiber axis, and polarization mode dispersion is 0.2 ps/rtkm or less.

In this multicore optical fiber, the plurality of cores includes the first core having the elliptical shape in the cross section orthogonal to the fiber axis and the one or more second cores different from the first core. In addition, the angle formed by the straight line connecting the center of gravity of the first core and the center of gravity of the core group including the one or more second cores and the straight line along the major axis of the elliptical shape of the first core is 30 degrees or less. In this case, birefringence caused by stress caused by the arrangement of the cores and birefringence caused by a shape of the core are canceled out, and birefringence of a waveguide mode propagating through the first core is reduced. As a result, the polarization mode dispersion can be reduced.

(2) In the above (1), non-circularity of the elliptical shape may be 10% or less. In this case, it is possible to reduce connection loss when the multicore optical fiber is connected to a normal optical fiber having small non-circularity.

(3) In the above (1) or (2), the plurality of cores and the cladding may contain fluorine, and the concentration of fluorine in the cladding may be higher than the concentration of fluorine in each of the plurality of cores. In this case, the core has a coefficient of thermal expansion larger than a coefficient of thermal expansion of the cladding, and the core contracts more strongly than the cladding due to cooling when the multicore optical fiber is drawn, so that compressive stress remains in the cladding close to the core in a circumferential direction of the core. As a result, although birefringence is caused by stress caused by the arrangement of the cores, the birefringence is canceled out by birefringence caused by the shape of the core, so that polarization mode dispersion can be reduced.

(4) In any one of the above (1) to (3), the cladding may include first cladding surrounding the plurality of cores and second cladding surrounding the first cladding, the first cladding and the second cladding may contain fluorine, the concentration of fluorine in the first cladding may be higher than the concentration of fluorine in the second cladding, and the plurality of cores may contain at least one kind of alkali element of an alkali element group including an alkali metal element and an alkaline earth metal element. In this case, for example, tensile tension caused by the drawing can be localized in the second cladding, a glass defect caused by the tensile tension can be prevented from occurring in the core and the first cladding, and loss of the multicore optical fiber can be reduced.

(5) In any one of the above (1) to (4), the plurality of cores may contain at least one kind of element of an alkali element group including an alkali metal element and an alkaline earth metal element, and the concentration of an alkali element in the plurality of cores may be 1 wtppm or more and 3000 wtppm or less. In this case, the viscosity of the core is sufficiently reduced, and excessive loss caused by the high concentration of the alkali element can be reduced. Therefore, the polarization mode dispersion and loss in the multicore optical fiber can be reduced.

(6) In any one of the above (1) to (5), the angle formed by the straight line connecting the center of gravity of the first core and the center of gravity of the core group including the one or more second cores and the straight line along the major axis of the elliptical shape may be 10 degrees or less. In this case, the polarization mode dispersion can be further reduced.

(7) In any one of the above (1) to (5), the angle formed by the straight line connecting the center of gravity of the first core and the center of gravity of the core group including the one or more second cores and the straight line along the major axis of the elliptical shape may be 5 degrees or less. In this case, the polarization mode dispersion can be further reduced.

### Details of Embodiments of Present Disclosure

Specific examples of multicore optical fibers according to embodiments of the present disclosure will be described below with reference to the drawings. In the following description, the same reference signs will be used for the same elements or elements having the same functions, and the description will not be repeated to avoid redundancy. Note that the present disclosure is not limited to these examples, indicated by the claims, and intended to include all modifications within the meaning and scope equivalent to the claims.

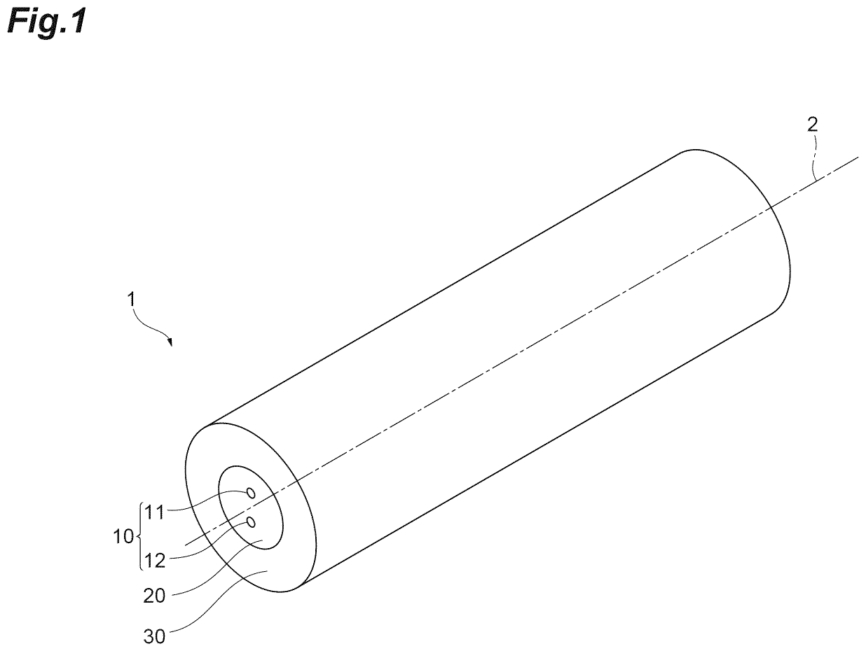

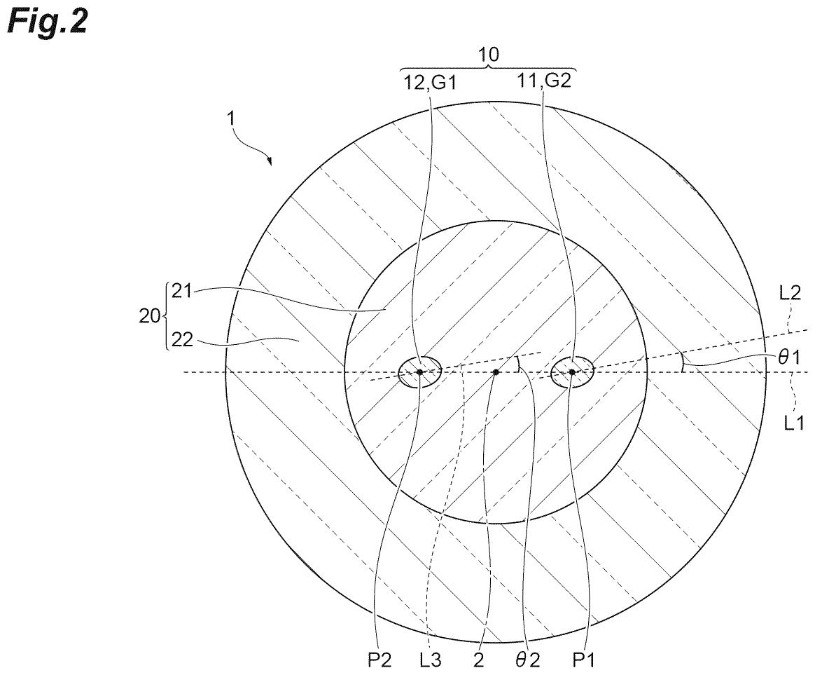

With reference to FIGS. 1 and 2, a configuration of an optical fiber 1 according to a first embodiment will be described. FIG. 1 is a perspective view of the optical fiber 1 according to the first embodiment. FIG. 2 is a cross-sectional view of the optical fiber 1 orthogonal to a fiber axis 2. In FIG. 2, illustration of a coating layer 30 is omitted. The optical fiber 1 includes a plurality of cores 10, cladding 20, and the coating layer 30. The optical fiber 1 may be, for example, an optical fiber used for long-distance large-capacity transmission. The optical fiber 1 is a multicore optical fiber (MCF) including the plurality of cores 10 and includes two cores 10 in the present embodiment. Hereinafter, each of the two cores 10 may be described while being distinguished as a core 11 or a core 12.

The core 10 is along the fiber axis 2 that is the central axis of the optical fiber 1. The core 10 contains silica glass as a main component. More specifically, each of the core 11 and the core 12 contains silica glass as a main component. In the present specification, that a certain member contains silica glass as a main component means that 95 mass % or more of the member is formed of silica glass. In other words, 95 mass % or more of the core 10 is formed of silica glass.

The core 10 (core 11 and core 12) contains at least one kind of alkali element of an alkali element group including an alkali metal element and an alkaline earth metal element. The alkali element is a term for an alkali metal element and an alkaline earth metal element in general. The alkali metal element is lithium (Li), sodium (Na), potassium (K), rubidium (Rb), or the like. The alkaline earth metal element is magnesium (Mg), calcium (Ca), strontium (Sr), barium (Ba), or the like. The concentration of the alkali element in the core 10 is 1 wtppm or more and 3000 wtppm or less. The concentration of the alkali element in the core 10 may be 10 wtppm or more and 300 wtppm or less.

The core 10 contains fluorine (F). The concentration of fluorine in the core 10 may be 1000 wtppm or more and 5000 wtppm or less. The composition of the core 10 and the cladding 20 can be calculated from known weight per atom by measuring a ratio of the number of atoms using a known method such as an electron probe micro analyzer (EPMA).

A refractive index of the core 10 is higher than a refractive index of the cladding 20. As a result, light input to the optical fiber 1 is guided by the core 10. A relative refractive index difference of the core 10 with respect to the cladding 20 is, for example, 0.3% or more and 0.6% or less. The refractive indexes of the core 10 and the cladding 20 can be measured by a known method such as a refracted near field (RNF) method. In the optical fiber 1, a refractive index of a certain region (portion) is defined as an average value of refractive indexes in the region. A diameter (core diameter) of the core 10 is, for example, 7 μm or more and 14 μm or less. A single LP mode including two polarization modes is guided to the core 10.

The cladding 20 surrounds the core 10. As illustrated in FIG. 2, the cladding 20 has first cladding 21 surrounding the core 10 and second cladding 22 surrounding the first cladding 21. The cladding 20 contains silica glass as a main component. More specifically, each of the first cladding 21 and the second cladding 22 contains silica glass as a main component. In addition, the cladding 20 contains fluorine. The concentration of fluorine in the cladding 20 is higher than the concentrations of fluorine in the core 11 and the core 12. More specifically, each of the first cladding 21 and the second cladding 22 contains fluorine. The concentration of fluorine in the first cladding 21 and the second cladding 22 is higher than the concentration of fluorine in the core 11 and the core 12. The concentration of fluorine in the first cladding 21 is higher than the concentration of fluorine in the second cladding 22. The concentration of fluorine in the first cladding 21 may be 8000 wtppm or more and 16000 wtppm or less. The concentration of fluorine in the second cladding 22 may be 0.5 times or higher and 0.9 times or less the concentration of fluorine in the first cladding 21.

An outer diameter (diameter) of the second cladding 22 may be, for example, 124 μm or more and 126 μm or less. In a case where the diameter of the second cladding 22 is 124 μm or more and 126 μm or less, a standard fusion splicer or a connection means such as a connector can be used when the optical fiber 1 that is a first optical fiber is connected to a second optical fiber. A ratio of an outer diameter (diameter) of the first cladding 21 to an outer diameter of the second cladding 22 may be 0.4 or more and 0.7 or less.

The coating layer 30 surrounds the cladding 20 and is in close contact with an outer peripheral surface of the cladding 20. The coating layer 30 is formed of, for example, a resin such as acrylate.

As illustrated in FIG. 2, the core 10 has an elliptical shape in a cross section orthogonal to the fiber axis 2. That the core 10 has an elliptical shape means that the non-circularity of an ellipse when a boundary line between the core 10 and the cladding 20 is fitted to the ellipse is non-zero. In a case where a long diameter of the ellipse is Rmax and a short diameter is Rmin, the non-circularity is 100×2×(Rmax−Rmin)/(Rmax+Rmin) %.

In the cross section of the optical fiber 1, a boundary line between regions having different refractive indexes, such as the core 10 and the cladding 20, is defined as a curve including a point where a gradient of the refractive index is the steepest (in a case where there is a plurality of the points, a center of gravity of the points). For example, the boundary line between the core 10 and the cladding 20 is defined as a closed curve in which a gradient of the refractive index averaged along the closed curve is maximized when the closed curve is set between the core 10 and the cladding 20. In the present embodiment, the non-circularity of the elliptical shape of the core 10 is 0.1% or more and 10% or less. The non-circularity of the elliptical shape may be 0.3% or more or may be 1% or more. The non-circularity of the elliptical shape of the core 10 is defined as a non-circularity of an ellipse when the boundary line between the core 10 and the cladding 20 is fitted to the ellipse.

The core 10 has a center of gravity in the cross section orthogonal to the fiber axis 2. The center of gravity of the core 10 is a center of gravity of a cross-sectional shape of the core 10 (a figure surrounded by the boundary line between the core 10 and the cladding 20). As illustrated in FIG. 2, the core 11 has a center of gravity P1, and the core 12 has a center of gravity P2. FIG. 2 illustrates a straight line L1 and a straight line L2. The straight line L1 is a straight line connecting the center of gravity P1 of the core 11 and the center of gravity P2 of the core 12. The straight line L2 is a straight line along a major axis of an elliptical shape of the core 11. A straight line L3 is a straight line along a major axis of an elliptical shape of the core 12. The major axis of the elliptical shape of the core 10 is defined as, for example, the major axis of an ellipse when the boundary line between the core 10 and the cladding 20 is fitted to the ellipse.

The arrangement of the cores 10 in the optical fiber 1 will be described. The plurality of cores 10 includes at least one first core and one or more second cores different from the first core. In the optical fiber 1, in the cross section orthogonal to the fiber axis 2, the first core is disposed so that an angle formed by a straight line connecting a center of gravity of the first core and a center of gravity of a core group including one or more second cores and a straight line along a major axis of an elliptical shape of the first core is 30 degrees or less. Here, the “core group including one or more second cores” is all the cores 10 excluding the first core among the plurality of cores 10, and in a case where the number of cores 10 included in the optical fiber 1 is two as in the present embodiment, the core group includes only one core 10, and in a case where the number of cores 10 is three or more, the core group includes two or more cores 10.

In the optical fiber 1, each of the core 11 and the core 12 is the first core. In other words, in a case where the core 11 is the first core, the core 12 is the second core, and in a case where the core 12 is the first core, the core 11 is the second core. Therefore, in the cross section orthogonal to the fiber axis 2, the core 11 is disposed so that an angle θ1 formed by the straight line L1 connecting the center of gravity P1 of the core 11 (first core) and the center of gravity P2 of a core group G1 of the second core (only core 12 in this example) and the straight line L2 along the major axis of the elliptical shape of the core 11 is 30 degrees or less. In addition, the core 12 is disposed so that an angle θ2 formed by the straight line L1 connecting the center of gravity P2 of the core 11 (first core) and the center of gravity P1 of a core group G2 of the second core (only core 11 in this example) and the straight line L3 along the major axis of the elliptical shape of the core 12 is 30 degrees or less. The angle formed by the straight line connecting the center of gravity of the first core and the center of gravity of the core group including one or more second cores and the straight line along the major axis of the elliptical shape of the first core may be 10 degrees or less or may be 5 degrees or less.

In the optical fiber 1, an interval between the core 11 and the core 12 may be, for example, 15 μm or more and 60 μm or less or may be 25 μm or more and 50 μm or less. The interval between the core 11 and the core 12 is defined as a distance between the center of gravity P1 of the core 11 and the center of gravity P2 of the core 12. From the viewpoint of reducing crosstalk, the interval between the core 11 and the core 12 may be increased, and from the viewpoint of facilitating the connection of the optical fiber 1, the interval may be decreased. In a case where the interval between the core 11 and the core 12 is 15 μm or more and 60 μm or less, or 25 μm or more and 50 μm or less, it is possible to facilitate the connection of the optical fiber 1 while reducing the crosstalk.

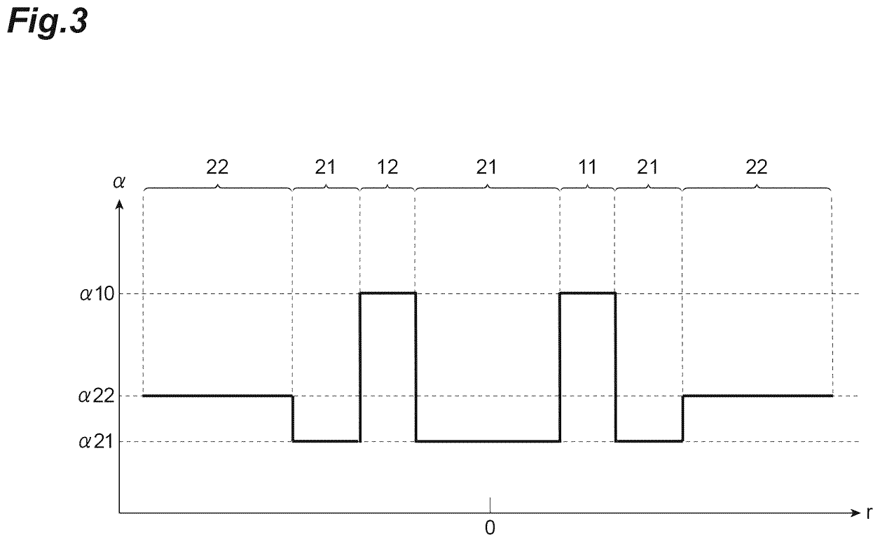

FIG. 3 is a graph schematically illustrating a distribution of a coefficient of thermal expansion in the optical fiber 1. FIG. 3 illustrates a coefficient of thermal expansion α of a portion located on the straight line L1 in the optical fiber 1 of FIG. 2. A horizontal axis in FIG. 3 illustrates a position r on the straight line L1. A center position r of a line segment connecting the center of gravity P1 and the center of gravity P2 is set to 0. A vertical axis in FIG. 3 illustrates the coefficient of thermal expansion α. Specifically, a coefficient of thermal expansion α10 of the core 11 and the core 12, a coefficient of thermal expansion α21 of the first cladding 21, and a coefficient of thermal expansion α22 of the second cladding 22 are illustrated. The coefficient of thermal expansion can be measured as elongation or shrinkage due to a change in temperature. The coefficient of thermal expansion in the present specification is a value at 1000° C., but may be a value at a temperature of 700° C. or less at which measurement is easier.

As described above, each of the core 11, the core 12, the first cladding 21, and the second cladding 22 contains fluorine. The concentration of fluorine in the second cladding 22 is higher than the concentrations of fluorine in the core 11 and the core 12. As a result, the second cladding 22 has the coefficient of thermal expansion α10 smaller than the coefficient of thermal expansion α22 of the core 11 and the core 12. In addition, the concentration of fluorine in the first cladding 21 is higher than the concentration of fluorine in the second cladding 22. As a result, the first cladding 21 has the coefficient of thermal expansion α21 smaller than the coefficient of thermal expansion α22 of the second cladding 22.

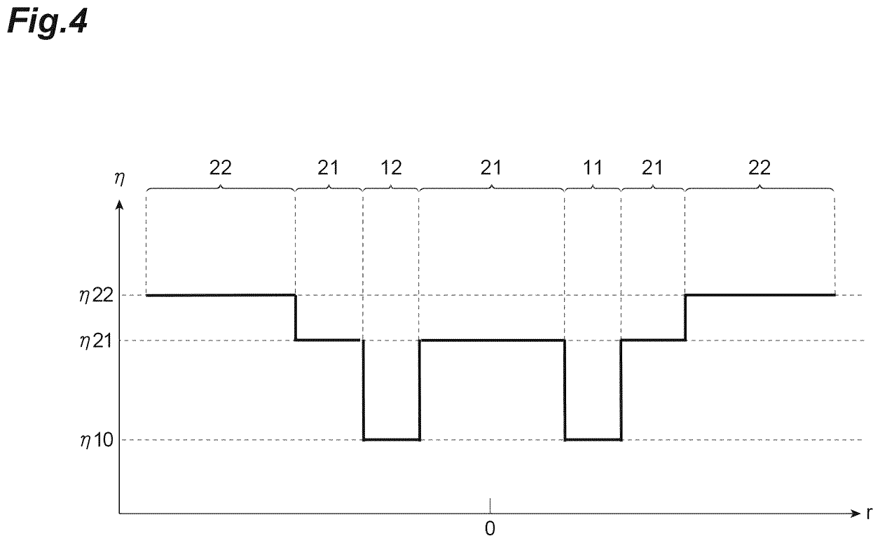

FIG. 4 is a graph schematically illustrating a distribution of viscosity in the optical fiber 1. FIG. 4 illustrates viscosity n of a portion located on the straight line L1 in the optical fiber 1 of FIG. 2. A horizontal axis in FIG. 4 illustrates a position r on the straight line L1, and a vertical axis in FIG. 4 illustrates the viscosity n. Specifically, viscosity η10 of the core 11 and the core 12, viscosity η21 of the first cladding 21, and viscosity η22 of the second cladding 22 are illustrated.

As described above, the core 11 and the core 12 contain at least one kind of element of the alkali element group including an alkali metal element and an alkaline earth metal element. As a result, the core 11 and the core 12 have the viscosity η10 lower than the viscosity η21 of the first cladding 21 and the viscosity η22 of the second cladding 22. In addition, the viscosity η21 of the first cladding 21 is lower than the viscosity η22 of the second cladding 22.

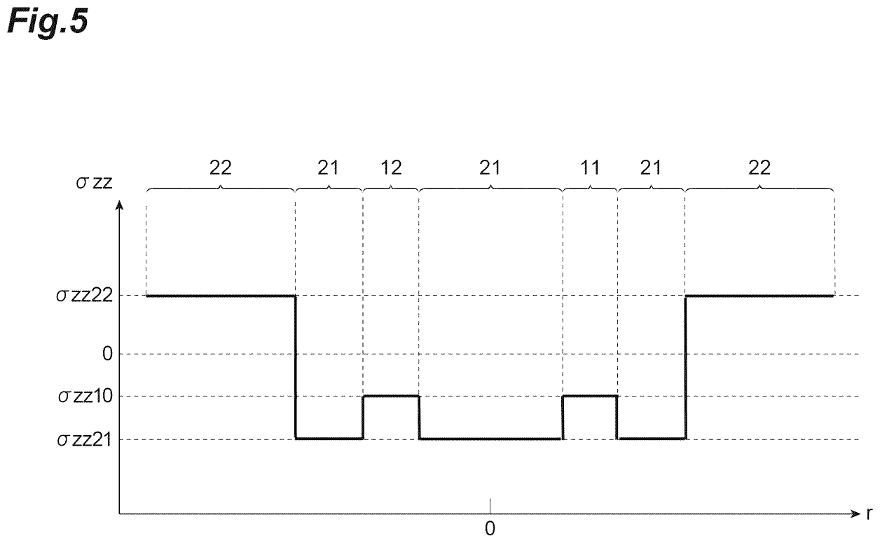

FIG. 5 is a graph schematically illustrating a distribution of stress in the optical fiber 1. FIG. 5 illustrates stress σzz caused in a portion located on the straight line L1 in the optical fiber 1 of FIG. 2. A horizontal axis in FIG. 5 illustrates a position r on the straight line L1, and a vertical axis in FIG. 5 illustrates the stress σzz. Specifically, stress σzz10 caused in the core 11 and the core 12, stress σzz21 caused in the first cladding 21, and stress σzz22 caused in the second cladding 22 are illustrated. In a direction along the fiber axis 2, tension is illustrated as being positive and compression is illustrated as being negative.

As described above, since the second cladding 22 has the relatively high viscosity η22, the second cladding 22 has positive axial stress (stress σzz22) due to tension when the optical fiber 1 is drawn. Meanwhile, since the viscosity n 10 of the cores 11 and 12 and the viscosity η21 of the first cladding 21 are relatively low, the cores 11 and 12 and the first cladding 21 have negative axial stress (stress σzz10, and σzz21). The coefficient of thermal expansion α21 of the first cladding 21 is smaller than the coefficient of thermal expansion α10 of the core 11 and the core 12. Therefore, the first cladding 21 has negative axial stress (stress σzz21) larger than that of the core 11 and the core 12 due to contraction caused by cooling when the optical fiber 1 is drawn.

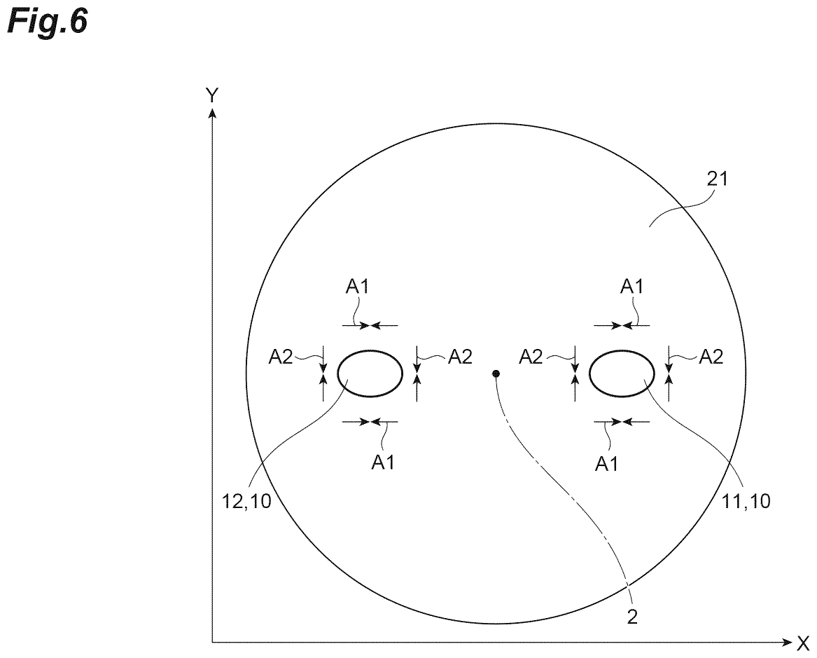

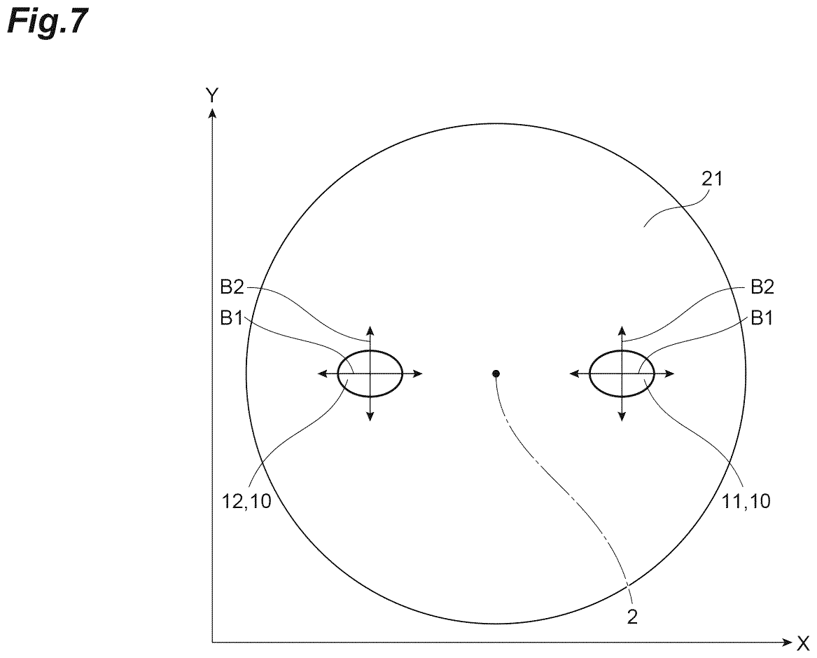

With reference to FIGS. 6 and 7, birefringence caused in the core 10 will be described. Specifically, with reference to FIG. 6, birefringence caused by the stress caused by the arrangement of the cores 10 will be described, and with reference to FIG. 7, birefringence caused by a shape of the core 10 will be described. FIG. 6 is a view schematically illustrating in-plane stress in a cross section orthogonal to the fiber axis 2. FIG. 7 is a view schematically illustrating a slow axis direction of birefringence of the fundamental mode in the core 10. FIGS. 6 and 7 schematically illustrate cross sections of the core 10 and the first cladding 21, and hatching is omitted for convenience of description. In FIGS. 6 and 7, a direction along the straight line L1 (see FIG. 2) connecting the center of gravity P1 of the core 11 and the center of gravity P2 of the core 12 is defined as an X direction, and a direction orthogonal to the X direction and a direction along the fiber axis 2 is defined as a Y direction. In an example illustrated in FIGS. 6 and 7, in the cross section orthogonal to the fiber axis 2, a cross-sectional shape of the core 10 has an elliptical shape, and the core 10 is disposed so that the major axis of the elliptical shape is along the X direction.

As described above, the first cladding 21 has the coefficient of thermal expansion α10 smaller than the coefficient of thermal expansion α21 of the core 10. In other words, since the coefficient of thermal expansion α10 of the core 10 is larger than the coefficient of thermal expansion α21 of the first cladding 21, the core 10 contracts more strongly than the first cladding 21 due to cooling when the optical fiber 1 is drawn, and compressive stress remains in a circumferential direction of the core 10 in the first cladding 21 close to the core 10. FIG. 6 illustrates residual compressive stress A1 and A2. Specifically, among the residual compressive stress, compressive stress along the X direction is illustrated as the compressive stress A1, and compressive stress along the Y direction is illustrated as the compressive stress A2.

When the compressive stress remaining in the circumferential direction of the first core (for example, core 11) included in the plurality of cores 10 is examined, in a direction (X direction) in which the second core (for example, core 12) different from the first core exists, the compressive stress A2 along a circumferential direction (Y direction) of the first core is weakened by the influence of contraction of the second core. Therefore, anisotropy occurs in the compressive stress along the circumferential direction of the core, and when the compressive stress is averaged, compressive stress along the X direction (direction in which the cores are arranged) becomes relatively large. As a result, a refractive index with respect to polarization in the X direction becomes lower than a refractive index with respect to polarization in the Y direction, and birefringence is caused. Therefore, in this example, birefringence is caused in the core 10 by stress caused by the arrangement of the cores 10, and a slow axis of the birefringence (polarization direction in which the refractive index is high) is along the Y direction.

In a case where the core 10 has an elliptical shape as illustrated in FIG. 7, birefringence is caused also by the shape of the core 10. FIG. 7 schematically illustrates a slow axis B1 and a fast axis B2 of the birefringence caused by the shape of the core 10. The slow axis B1 of the birefringence is along the major axis of the elliptical shape, and the fast axis is along the minor axis. In this example, the major axis of the elliptical shape is along the X direction. Therefore, in this example, the slow axis B1 of the birefringence caused by the shape of the core 10 is along the X direction.

As described above, the birefringence caused by the stress caused by the arrangement of the cores 10 and the birefringence caused by the shape of the core 10 have opposite signs, and the birefringence caused by the stress caused by the arrangement of the cores 10 and the birefringence caused by the shape of the core 10 are combined, whereby birefringence as a whole is reduced. The birefringence is reduced, whereby polarization mode dispersion is reduced.

In the examples of FIGS. 6 and 7, the major axis of the elliptical shape of the core 10 coincides with the X direction (that is, the direction along the straight line L1 connecting the center of gravity P1 of the core 11 and the center of gravity P2 of the core 12). However, as in the optical fiber 1 illustrated in FIG. 2, even if the major axis of the elliptical shape does not completely coincide with the straight line L1, if the major axis of the elliptical shape is approximately along the straight line L1 (for example, when the angle formed by the straight line L1 and the straight lines L2 and L3 along the major axis of the elliptical shape is 30 degrees or less,), the birefringence caused by stress caused by the arrangement of the cores 10 and the birefringence caused by the shape of the core 10 are canceled out, and the birefringence is reduced as a whole. As a result, the polarization mode dispersion is reduced.

In the optical fiber 1, birefringence obtained by combining the birefringence caused by the stress caused by the arrangement of the cores 10 and the birefringence caused by the shape of the core 10 is 10-6 or less.

The combined birefringence may be 10-7 or less. Unless stated otherwise, the birefringence refers to a value at a wavelength of 1550 nm of a fundamental mode guided into the core 10 (for example, core 11). In addition, the polarization mode dispersion is 0.2 ps/rtkm or less. The polarization mode dispersion may be 0.1 ps/rtkm or less. Unless stated otherwise, the polarization mode dispersion refers to a value at a wavelength of 1550 nm of the fundamental mode guided to the core 10 (for example, core 11). The polarization mode dispersion can be measured using a known method such as a Jones matrix eigenanalysis (JME) method. At the time of measurement, measurement light is input to a core that is an object subject to measurement of the multicore optical fiber to be measured of the multicore optical fiber, and measurement light output from the core is captured and measured. Although a known input/output device such as a fan-out device may be used to selectively input and output the measurement light to and from the core to be measured, it is assumed that the polarization mode dispersion of the input/output device is negligibly small or appropriately corrected from a measurement result.

As described above, in the optical fiber 1 according to the present embodiment, the plurality of cores 10 includes the core 11 and the core 12 having elliptical shapes in the cross section orthogonal to the fiber axis 2. The angle θ1 formed by the straight line L1 connecting the center of gravity P1 of the core 11 and the center of gravity P2 of the core 12 and the straight line L2 along the major axis of the elliptical shape of the core 11 is 30 degrees or less. In addition, the angle θ2 formed by the straight line L1 and the straight line L3 along the major axis of the elliptical shape of the core 12 is 30 degrees or less. As a result, the birefringence caused by the stress caused by the arrangement of the cores 10 and the birefringence caused by the shape of the core 10 are canceled out, and birefringence of a waveguide mode propagating through the core 10 is reduced. As a result, the polarization mode dispersion can be reduced. In addition, the angle θ1 and the angle θ2 may be 10 degrees or less or may be 5 degrees or less. In this case, the polarization mode dispersion can be further reduced.

The non-circularity of the elliptical shape of the core 10 is 10% or less. As a result, it is possible to reduce connection loss when the optical fiber 1 is connected to a normal optical fiber having small non-circularity.

The core 10 and the cladding 20 contain fluorine, and the concentration of fluorine in the cladding 20 is higher than the concentration of fluorine in each of the plurality of cores 10. As a result, the core 10 has the coefficient of thermal expansion α10 larger than the coefficient of thermal expansion α21 of the first cladding 21, and the core 10 contracts more strongly than the first cladding 21 due to cooling when the optical fiber 1 is drawn, so that the compressive stress remains in the circumferential direction of the core 10 in the first cladding 21 close to the core 10. As a result, although birefringence is caused by the stress caused by the arrangement of the cores 10, the birefringence is canceled out by the birefringence caused by the shape of the core 10, so that the polarization mode dispersion can be reduced.

The cladding 20 has the first cladding 21 surrounding the core 10 and the second cladding 22 surrounding the first cladding 21. The first cladding 21 and the second cladding 22 contain fluorine. The concentration of fluorine in the first cladding 21 is higher than the concentration of fluorine in the second cladding 22. The core 10 contains at least one kind of alkali element of an alkali element group including an alkali metal element and an alkaline earth metal element. In this case, for example, tensile tension caused by the drawing can be localized in the second cladding 22, a glass defect caused by the tensile tension can be prevented from occurring in the core 10 and the first cladding 21, and loss of the optical fiber 1 can be reduced.

The core 10 contains at least one kind of element of the alkali element group including an alkali metal element and an alkaline earth metal element. The concentration of the alkali element in the core 10 is 1 wtppm or more and 3000 wtppm or less. As a result, the viscosity of the core 10 is sufficiently reduced, and excessive loss caused by the high concentration of the alkali element can be reduced. Therefore, the polarization mode dispersion and the loss in the optical fiber 1 can be reduced.

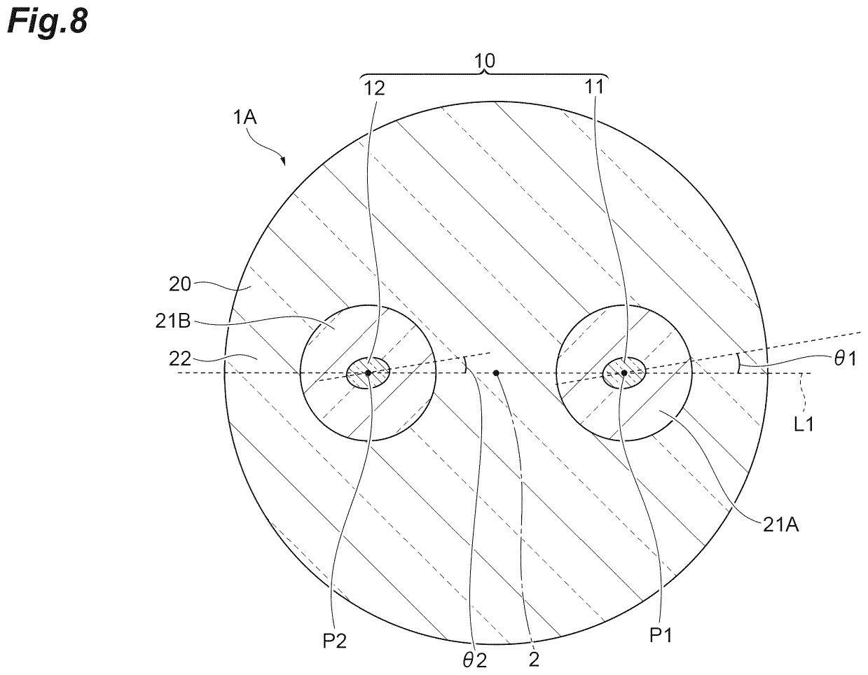

With reference to FIG. 8, an optical fiber 1A according to a second embodiment will be described. FIG. 8 is a cross-sectional view of the optical fiber 1A according to the second embodiment. FIG. 8 illustrates a cross section of the optical fiber 1A orthogonal to a fiber axis 2, and illustration of a coating layer 30 is omitted. The optical fiber 1A according to the present embodiment is different from the optical fiber 1 according to the first embodiment in that the optical fiber 1A according to the present embodiment includes a plurality of (two) pieces of first cladding 21A and 21B. Except for points to be described below, a core 10 according to the second embodiment has a configuration similar to that of the core 10 according to the first embodiment, and the first cladding 21A and 21B according to the second embodiment have configurations similar to that of the first cladding 21 according to the first embodiment.

The first cladding 21A surrounds a core 11, and the first cladding 21B surrounds a core 12. The first cladding 21A and the first cladding 21B are separated from each other with second cladding 22 interposed therebetween. The second cladding 22 surrounds the first cladding 21A and the first cladding 21B. In other words, the first cladding 21A and 21B are surrounded by the common second cladding 22. A ratio of an outer diameter of each piece of the first cladding 21A and 21B to an outer diameter of the core 10 may be 2 or more and 5 or less.

In the optical fiber 1A, an interval between the core 11 and the core 12 may be, for example, 25 μm or more and 70 μm or less or may be 35 μm or more and 60 μm or less. From the viewpoint of reducing crosstalk, the interval between the core 11 and the core 12 may be increased, and from the viewpoint of facilitating the connection of the optical fiber 1A, the interval may be decreased. In a case where the interval between the core 11 and the core 12 is 25 μm or more and 70 μm or less, or 35 μm or more and 60 μm or less, it is possible to facilitate the connection of the optical fiber 1A while reducing the crosstalk.

Also in the optical fiber 1A, similarly to the optical fiber 1, a plurality of cores 10 includes the core 11 and the core 12 having elliptical shapes in the cross section orthogonal to the fiber axis 2. The angle θ1 formed by the straight line L1 connecting the center of gravity P1 of the core 11 and the center of gravity P2 of the core 12 and the straight line L2 along the major axis of the elliptical shape of the core 11 is 30 degrees or less. In addition, an angle θ2 formed by the straight line L1 and the straight line L3 along a major axis of the elliptical shape of the core 12 is 30 degrees or less. As a result, the birefringence caused by the stress caused by the arrangement of the cores 10 and the birefringence caused by the shape of the core 10 are canceled out, and birefringence of a waveguide mode propagating through the core 10 is reduced. As a result, also in the optical fiber 1A, polarization mode dispersion can also be reduced.

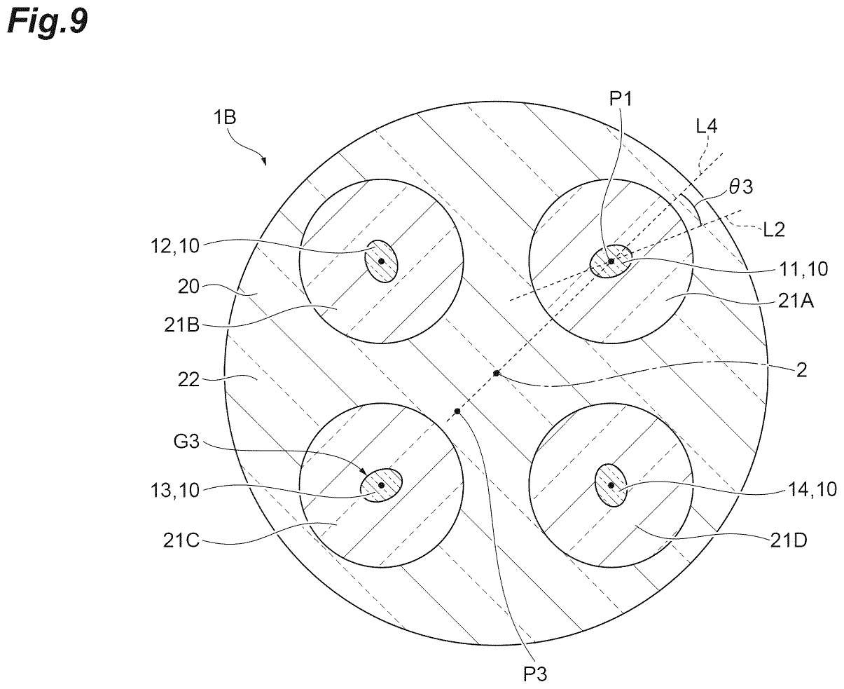

With reference to FIG. 9, an optical fiber 1B according to a third embodiment will be described. FIG. 9 is a cross-sectional view of the optical fiber 1B according to the third embodiment. FIG. 9 illustrates a cross section of the optical fiber 1B orthogonal to a fiber axis 2, and illustration of a coating layer 30 is omitted. The optical fiber 1B according to the present embodiment is different from the optical fiber 1 according to the first embodiment in that the optical fiber 1B according to the present embodiment includes four cores 10 and four pieces of first cladding 21A, 21B, 21C, and 21D. Hereinafter, the respective four cores 10 may be described while being distinguished as cores 11, 12, 13, and 14. In addition, except for points to be described below, the core 10 according to the third embodiment has a configuration similar to that of the core 10 according to the first embodiment, and the first cladding 21A, 21B, 21C, and 21D according to the third embodiment have configurations similar to that of the first cladding 21 according to the first embodiment.

The first cladding 21A surrounds the core 11. The first cladding 21B surrounds the core 12. The first cladding 21C surrounds the core 13. The first cladding 21D surrounds the core 14. The first cladding 21A, 21B, 21C, and 21D are separated from each other with second cladding 22 interposed therebetween. The second cladding 22 surrounds the first cladding 21A, 21B, 21C, and 21D. In other words, the first cladding 21A, 21B, 21C, and 21D are surrounded by the common second cladding 22. A ratio of an outer diameter of each piece of the first cladding 21A, 21B, 21C, and 21D to the outer diameter of the core 10 may be 2 or more and 5 or less.

In the optical fiber 1B, an interval between the core 11 and the core 12 may be, for example, 25 μm or more and 70 μm or less or may be 35 μm or more and 60 μm or less. From the viewpoint of reducing crosstalk, the interval between the core 11 and the core 12 may be increased, and from the viewpoint of facilitating the connection of the optical fiber 1B, the interval may be decreased. In a case where the interval between the core 11 and the core 12 is 25 μm or more and 70 μm or less, or 35 μm or more and 60 μm or less, it is possible to facilitate the connection of the optical fiber 1B while reducing the crosstalk. For a similar reason, an interval between the core 12 and the core 13, an interval between the core 13 and the core 14, and an interval between the core 14 and the core 11 may be, for example, 25 μm or more and 70 μm or less or may be 35 μm or more and 60 μm or less.

Similarly to the core 10 according to the first embodiment, the core 10 (cores 11, 12, 13, and 14) according to the third embodiment has an elliptical shape in a cross section orthogonal to the fiber axis 2. In the present embodiment, the non-circularity of the elliptical shape of the core 10 is 0.1% or more and 10% or less. The non-circularity of the elliptical shape may be 0.3% or more or may be 1% or more. FIG. 9 illustrates a straight line L2 and a straight line L4. The straight line L2 is a straight line along a major axis of an elliptical shape of the core 11. The straight line L4 is a straight line L4 connecting a center of gravity P1 of the core 11 and a center of gravity P3 of a core group G3 including the core 10 (cores 12, 13, and 14) different from the core 11. In the optical fiber 1B, in the cross section orthogonal to the fiber axis 2, the core 11 is disposed so that an angle θ3 formed by the straight line L4 connecting the center of gravity P1 of the core 11 and the center of gravity P3 of the core group G3 including the core 10 different from the core 11 and the straight line L2 along the major axis of the elliptical shape of the core 11 is 30 degrees or less.

In the optical fiber 1B, the cores 12, 13, and 14 are disposed according to conditions similar to those of the core 11. In other words, the core 12 is disposed so that an angle formed by a straight line connecting a center of gravity of the core 12 and the center of gravity of a core group including the core 10 (cores 11, 13, and 14) different from the core 12 and a straight line along a major axis of an elliptical shape of the core 12 is 30 degrees or less. The core 13 is disposed so that an angle formed by a straight line connecting a center of gravity of the core 13 and a center of gravity of a core group including the core 10 (cores 11, 12, and 14) different from the core 13 and a straight line along a major axis of an elliptical shape of the core 13 is 30 degrees or less. The core 14 is disposed so that an angle formed by a straight line connecting a center of gravity of the core 14 and a center of gravity of a core group including the core 10 (core 11, 12, and 13) different from the core 14 and a straight line along a major axis of an elliptical shape of the core 14 is 30 degrees or less.

Also in the optical fiber 1B, similarly to the optical fiber 1, a plurality of cores 10 includes the cores 11, 12, 13, and 14 having elliptical shapes in the cross section orthogonal to the fiber axis 2. The angle θ3 formed by the straight line L4 connecting the center of gravity P1 of the core 11 and the center of gravity P3 of the core group G3 including the core 10 (cores 12, 13, and 14) different from the core 11 and the straight line L2 along the major axis of the elliptical shape of the core 11 is 30 degrees or less. The cores 12, 13, and 14 are disposed according to conditions similar to those of the core 11. As a result, the birefringence caused by the stress caused by the arrangement of the cores 10 and the birefringence caused by the shape of the core 10 are canceled out, and birefringence of a waveguide mode propagating through the core 10 is reduced. As a result, also in the optical fiber 1B, polarization mode dispersion can be reduced.

Although the embodiments have been described above, the present disclosure is not necessarily limited to the embodiments described above, and various modifications are possible without departing from the spirit of the present disclosure. In addition, the above-described embodiments may be appropriately combined.

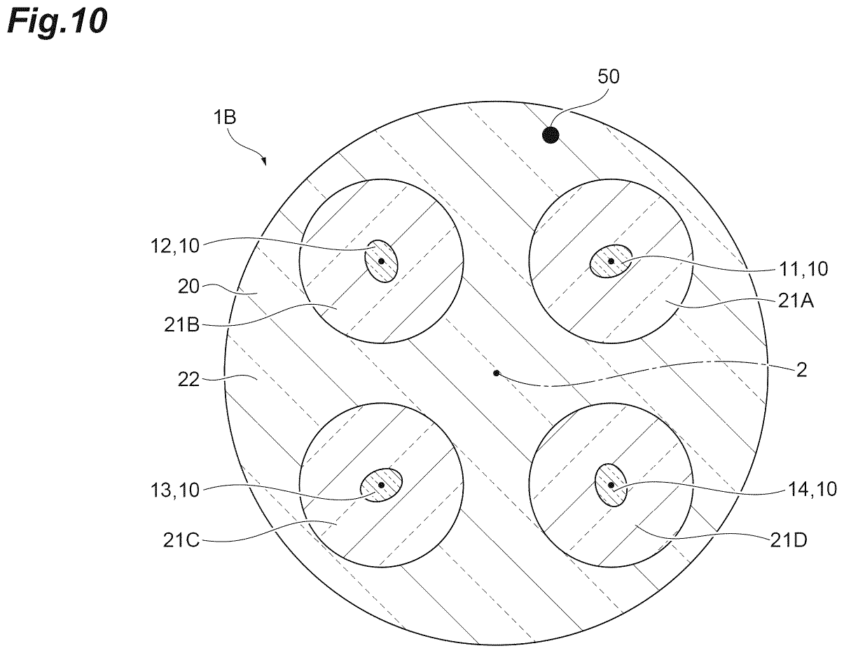

As illustrated in FIG. 10, an optical fiber 1B may have a marker 50 at a position where the symmetry of the arrangement of cores 10 is broken. As a result, each core 10 can be identified in the optical fiber 1B. The marker 50 may be formed, for example, in cladding 20 (second cladding 22). The marker 50 may be formed of a material having a refractive index different from a refractive index of the cladding 20 (second cladding 22). Also in optical fibers 1 and 1A, a marker for identifying each core 10 may be formed.

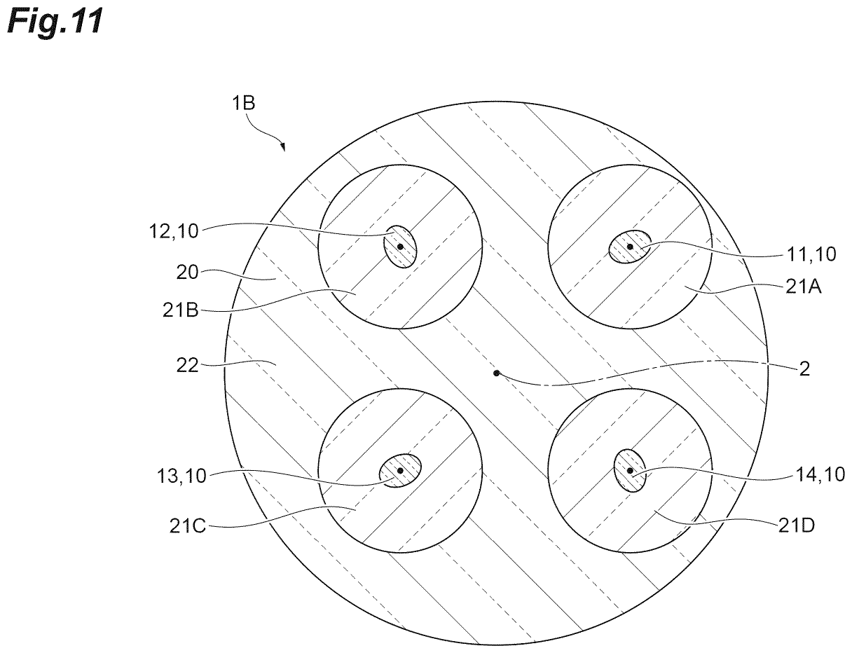

As illustrated in FIG. 11, in an optical fiber 1B, a core 10 may be disposed so as not to have rotational symmetry with respect to a fiber axis 2 (cladding center). In this example, a core 11 is disposed close to the outer edge of the cladding 20, as compared to cores 12, 13, and 14. As a result, each core 10 can be identified in the optical fiber 1B. Also in optical fibers 1 and 1A, a core 10 may be disposed so as not to have rotational symmetry with respect to a fiber axis 2 (cladding center).

In a cross section orthogonal to the fiber axis 2, the non-circularity of an elliptical shape of the core 10 may be 10% or more. The concentration of an alkali element in the core 10 may be 1 wtppm or less, or may be 3000 wtppm or more. The core 10 may contain, in addition to the alkali element, at least one of fluorine of 1000 wtppm or more and 5000 wtppm or less and chlorine (C1) of 100 wtppm or more and 3000 wtppm or less. In this case, the viscosity of the core 10 is reduced, and loss caused by density fluctuation or the like is reduced. The core 10 does not need to contain fluorine.

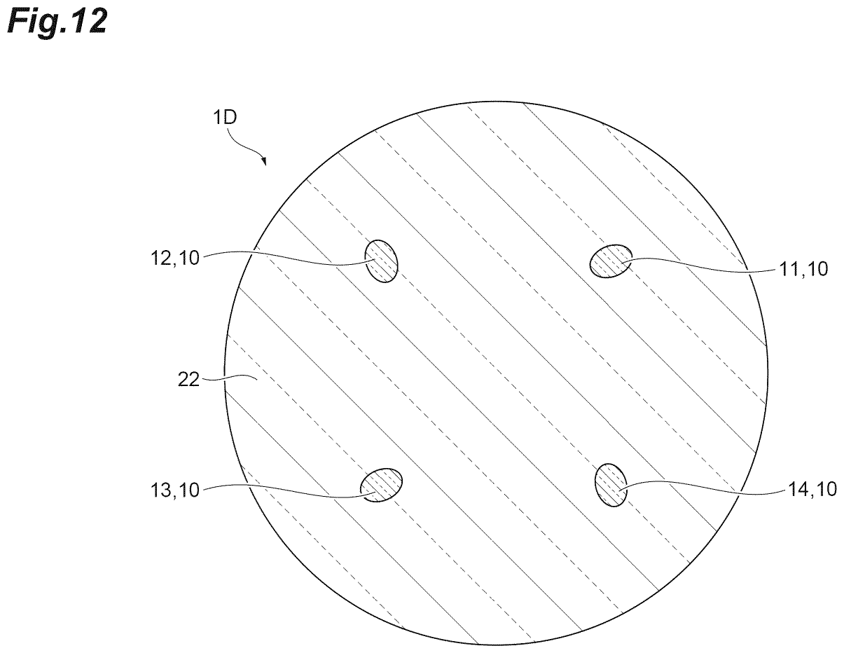

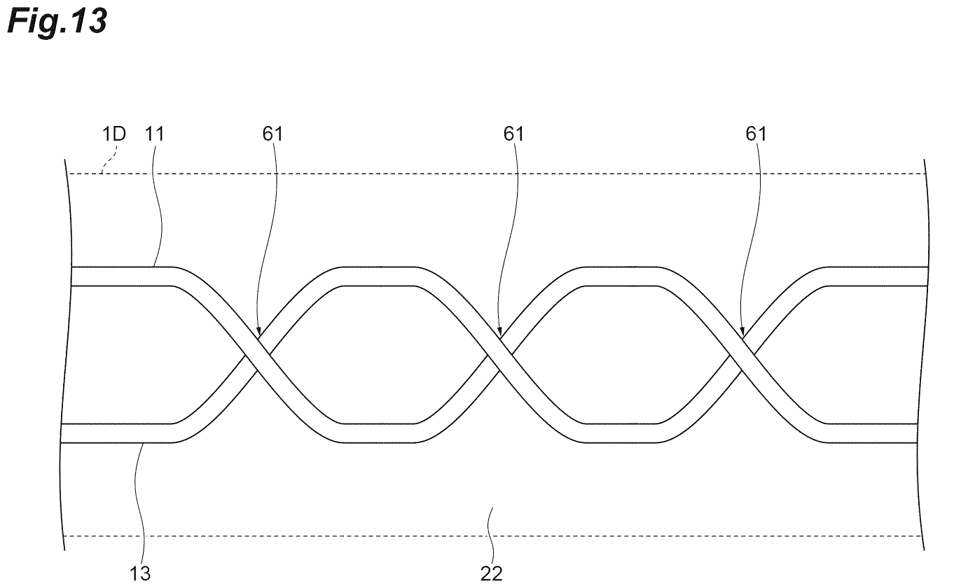

As illustrated in FIGS. 12 and 13, the optical fiber of the present embodiment described above may have a plurality of twists 61 arranged in a longitudinal direction. FIGS. 12 and 13 illustrate an optical fiber 1D having twists 61 as a modification of the optical fiber 1B illustrated in FIG. 9. FIG. 12 is a view schematically illustrating a cross section orthogonal to a longitudinal direction of the optical fiber 1D. FIG. 13 is a view schematically illustrating an internal structure of the optical fiber 1D in a case where the optical fiber 1D is viewed along a direction orthogonal to the longitudinal direction of the optical fiber 1D. In FIGS. 12 and 13, illustration of first cladding 21 and a coating layer 30 is omitted. In addition, in FIG. 13, illustration of cores 12 and 14 are further omitted, second cladding 22 is illustrated by a broken line, and cores 11 and 13 located inside the second cladding 22 are illustrated by a solid line. The optical fiber 1D has four cores 10 (cores 11, 12, 13, and 14). Each core 10 has an elliptical shape in a cross section orthogonal to a fiber axis (longitudinal direction of optical fiber 1D).

In the optical fiber 1D, the positions of a plurality of cores 11,12,13, and 14 change so as to rotate as a movement is performed along the longitudinal direction, whereby a plurality of twists 61 is formed so as to be positioned along the longitudinal direction of the optical fiber 1D. The twist 61 is a position (structure) at which a plurality of cores 10 intersects each other in a case where the optical fiber 1D is viewed along a direction orthogonal to the fiber axis. Since the optical fiber 1D has the twists 61, mode coupling occurs between two polarization modes in each core 10, and polarization mode dispersion caused by stress and shape anisotropy in a cross section of the optical fiber 1D is randomized by the mode coupling, and accumulation of the polarization mode dispersion is reduced. From this viewpoint, the number of twists (the number of twists 61) may be 0.1 rotations/m or more. In addition, the number of twists may be 1 rotation/m or more. Note that the number of twists is a value obtained by averaging an absolute value of a rotation angle per unit length in the longitudinal direction. A direction of the twist 61 can be two left and right directions (two directions along a circumferential direction of the optical fiber 1D), but twists 61 in two directions in the longitudinal direction may be mixed.

While the twist 61 has an effect of reducing the polarization mode dispersion, the twist 61 comes with a side effect that the arrangement of the plurality of cores 10 rotates in the longitudinal direction, and therefore, if an end portion of the optical fiber 1D is cut when light is coupled to an end surface of the optical fiber 1D, the arrangement of the cores changes, which may cause a problem that it is difficult to couple light. In order to reduce the influence of this problem, the number of twists 61 may be 3 rotations/m or less. In addition, the number of twists 61 may be 0.3 rotations/m or less.

What is claimed is:

1. A multicore optical fiber comprising:
a plurality of cores along a fiber axis; and
cladding surrounding the plurality of cores, wherein
the plurality of cores and the cladding contain silica glass as a main component,
a refractive index of each of the plurality of cores is higher than a refractive index of the cladding,
a coefficient of thermal expansion of each of the plurality of cores is larger than a coefficient of thermal expansion of the cladding,
the plurality of cores includes a first core having an elliptical shape in a cross section orthogonal to the fiber axis and one or more second cores different from the first core,
non-circularity of the elliptical shape is 0.1% or more,
an angle formed by a straight line connecting a center of gravity of the first core and a center of gravity of a core group including the one or more second cores and a straight line along a major axis of the elliptical shape is 30 degrees or less in the cross section orthogonal to the fiber axis, and
polarization mode dispersion is 0.2 ps/rtkm or less.

2. The multicore optical fiber according to claim 1, wherein
the non-circularity of the elliptical shape is 10% or less.

3. The multicore optical fiber according to claim 1, wherein
the plurality of cores and the cladding contain fluorine, and
a concentration of fluorine in the cladding is higher than a concentration of fluorine in each of the plurality of cores.

4. The multicore optical fiber according to claim 1, wherein
the cladding includes first cladding surrounding the plurality of cores and second cladding surrounding the first cladding,
the first cladding and the second cladding contain fluorine,
a concentration of fluorine in the first cladding is higher than a concentration of fluorine in the second cladding, and
the plurality of cores contains at least one kind of alkali element of an alkali element group including an alkali metal element and an alkaline earth metal element.

5. The multicore optical fiber according to claim 1, wherein
the plurality of cores contains at least one kind of alkali element of an alkali element group including an alkali metal element and an alkaline earth metal element, and
a concentration of the alkali element in the plurality of cores is 1 wtppm or more and 3000 wtppm or less.

6. The multicore optical fiber according to claim 1, wherein
the angle is 10 degrees or less.

7. The multicore optical fiber according to claim 1, wherein
the angle is 5 degrees or less.
